(19) United States
(12) Patent Application Publication
(10) Pub. No.: US 2011/0187748 A1
(43) Pub. Date: Aug. 4, 2011

(54) APPARATUS AND METHOD FOR ROTATING OUTPUT IMAGE IN MOBILE TERMINAL

(75) Inventor: Yoon-Gi LEE, Suwon-si (KR)

(73) Assignee: SAMSUNG ELECTRONICS CO. LTD., Suwon-si (KR)

(21) Appl. No.: 13/013,208

(22) Filed: Jan. 25, 2011

(30) Foreign Application Priority Data
Jan. 29, 2010 (KR) 10-2010-0008361

(51) Int. Cl. G09G 5/00

(52) U.S. Cl. 345/649

(57) ABSTRACT

An apparatus and a method for displaying an image in a mobile terminal are provided. More particularly, an apparatus and a method for rotating a displayed image in a direction and by an angle desired by a user through a simple touch input in a mobile terminal are provided. The apparatus includes an image rotator. The image rotator detects a user's touch input while an image is displayed to determine a rotation direction and a rotation angle for the image, and rotating the displayed image in the determined rotation direction by the determined rotation angle.

### PRIORITY

This application claims the benefit under 35 U.S.C. §119(a) of a Korean patent application filed in the Korean Intellectual Property Office on Jan. 29, 2010 and assigned Serial No. 10-2010-0008361, the entire disclosure of which is hereby incorporated by reference.

### BACKGROUND OF THE INVENTION

1. Field of the Invention

The present invention relates to an apparatus and a method for displaying an image in a mobile terminal. More particularly, the present invention relates to an apparatus and a method for rotating a displayed image in a direction and by an angle desired by a user through a simple touch input in a mobile terminal.

2. Description of the Related Art

Recently, a mobile terminal has rapidly evolved. The use of the mobile terminal is now ubiquitous in modern society and its capabilities have become indispensable to modern people. The mobile terminal is used as a medium that enables wireless voice and data communication.

Historically, the mobile terminal was merely recognized as a product that can be carried that enables wireless communication. However, as technology develops, service providers and terminal manufacturers competitively develop products (or services) for differentiation from one another.

For example, the mobile terminal has been developed to include capabilities for a phonebook, games, a Short Message Service (SMS), an Electronic (E)-mail, a morning call, a Motion Picture Expert Group (MPEG)-1 or MPEG-2 Audio Layer-3 (MP3) player, a schedule management function, a digital camera, and a wireless Internet service, and provides various services.

More particularly, since the digital camera function enables a user to obtain an image without carrying a separate camera, the digital camera function has become one of the most used functions. Accordingly, the digital camera function has become a basic function of the mobile terminal.

A user of the mobile terminal stores a plurality of images, which may be viewed by the user at a desired time.

However, the mobile terminal stores an image in an orientation corresponding to a shot angle. In other words, when the mobile terminal captures an image while the mobile terminal is in a vertical orientation, the mobile terminal may capture and store a vertically oriented image. In contrast, when the mobile terminal captures an image while the mobile terminal is in a horizontal orientation, the mobile terminal may capture and store a horizontally oriented image.

The mobile terminal may not only display a vertically oriented or horizontally oriented image, but may also rotate an image in a specific direction when displaying an image.

To rotate a vertically oriented or horizontally oriented image, a user selects a rotation menu of an image manage menu and rotates a displayed image according to a rotation angle desired by the user.

However, the above-described image rotating method has a shortcoming of having to enter a plurality of menus to rotate an image, and a shortcoming of only providing image rotation at fixed rotation angles (for example, 45°, 90°, etc.) in the menu.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for rotating a displayed image in a direction and by an angle desired by a user through a simple touch input in a mobile terminal.

Another aspect of the present invention is to provide an apparatus and a method for setting a rotation direction and a rotation angle of a displayed image through a touch input in a mobile terminal.

In accordance with an aspect of the present invention, an apparatus for rotating a displayed image in a mobile terminal is provided. The apparatus includes an image rotator for detecting a user's touch input while an image is displayed to determine a rotation direction and a rotation angle for the image, and rotating the displayed image in the determined rotation direction by the determined rotation angle.

In accordance with another aspect of the present invention, a method for rotating a displayed image in a mobile terminal is provided. The method includes detecting a user's touch input while an image is displayed to determine a rotation direction and a rotation angle for the image, and rotating the displayed image in the determined rotation direction by the determined rotation angle.

In accordance with another aspect of the present invention, an apparatus for rotating a displayed image in a mobile terminal is provided. The apparatus includes a memory unit for storing information regarding a rotation direction and a rotation angle that depends on at last one of a movement and direction of a user's touch input, a display unit for displaying a rotated image according to the user's touch input, an input unit for detecting the user's touch input for rotating an image; an image rotator for determining a rotation direction and a rotation angle that depends on the user's touch input, and a controller for controlling to rotate the image displayed on the display unit in the rotation direction by the rotation angle determined by the image rotator.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile terminal that rotates a displayed image through a touch input according to an exemplary embodiment of the present invention;

FIG. 2 is a flowchart illustrating a process for rotating a displayed image in a mobile terminal according to an exemplary embodiment of the present invention;

FIG. 3 is a flowchart illustrating a process for determining an image rotation angle in a mobile terminal according to an exemplary embodiment of the present invention;

FIG. 4A is a view illustrating a process for executing a function for vertically rotating an image that is being horizontally displayed in a mobile terminal according to an exemplary embodiment of the present invention;

FIG. 4B is a view illustrating a screen that displays an image rotation menu in a mobile terminal according to an exemplary embodiment of the present invention;

FIG. 4C is a view illustrating a process for setting a rotation angle for rotating an image in a mobile terminal according to an exemplary embodiment of the present invention; and

FIG. 4D is a view illustrating a screen in which an image has been rotated in a mobile terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for setting a rotation direction and a rotation angle of a displayed image desired by a user through a simple touch input, and rotating an image that is being displayed in the set direction and by angle using a mobile terminal.

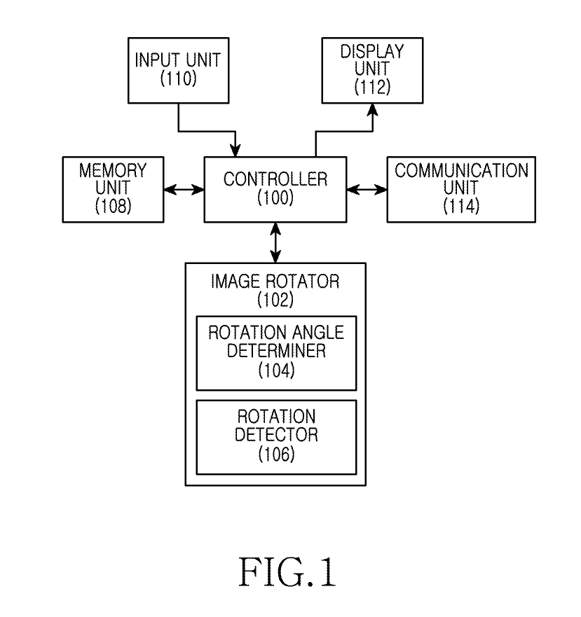

FIG. 1 is a block diagram illustrating a mobile terminal that rotates a displayed image through a touch input according to an exemplary embodiment of the present invention.

Referring to FIG. 1, the mobile terminal includes a controller 100, an image rotator 102, a memory unit 108, an input unit 110, a display unit 112, and a communication unit 114. The image rotator 102 may include a rotation angle determiner 104 and a rotation detector 106. The mobile terminal may include additional units that are not illustrated here merely for sake of clarity. Similarly, the functionality of two or more of the above units may be integrated into a single component.

The controller 100 of the mobile terminal controls an overall operation of the mobile terminal. For example, the controller 100 performs processes and controls for voice communication and data communication. In addition to the general functions, according to an exemplary embodiment of the present invention, the controller 100 controls an operation for rotating a displayed image in a direction and by an angle desired by a user through the user's simple touch input.

That is, when detecting the user's touch input while an image is being displayed, the controller 100 processes to display an image rotation menu, which is a menu that can set a rotation direction and a rotation angle of an image, and then processes to determine a rotation direction and a rotation angle desired by a user using the user's touch input and touch movement distance (i.e., movement direction).

At this point, the controller 100 controls the image rotator 102 to determine a rotation angle and a rotation direction, and rotates and displays an image that is being displayed according to the determination results of the image rotator 102.

The image rotator 102 determines a rotation direction and a rotation angle of the image that is being displayed under control of the controller 100.

At this point, the image rotator 102 may determine the rotation angle and the rotation direction using a touch movement distance and direction on the image rotation menu. For example, when a user of the mobile terminal moves the image rotation menu counterclockwise when the image rotation menu is touched, the image rotator 102 may determine that a rotation direction of the image that is being displayed is a counterclockwise direction. In addition, the image rotator 102 may determine a touch movement distance on the image rotation menu to which the user's touch has been input to determine a rotation angle of an image by which the user intends to rotate the image.

The rotation angle determiner 104 of the image rotator 102 serves as a block for determining a user's touch input to determine an angle by which the user intends to rotate an image that is being displayed. According to an exemplary embodiment of the present invention, the rotation angle determiner 104 may determine a rotation angle by determining a distance between a point where a user's touch input occurs and a point where the touch input is released. Alternatively, the rotation angle determiner 104 may determine a rotation angle of an image by defining a rotation angle in advance for every block of the image rotation menu, and then determining the number of blocks over which the user's touch moves.

The rotation detector 106 of the image rotator 102 serves as a block for detecting a user's touch input that is intended to rotate an image being displayed. When detecting a touch input on the image rotation menu, the rotation detector 106 determines the touch input as a touch input for rotating the image. In contrast, when detecting a touch input outside the image rotation menu, the rotation detector 106 may determine the touch input as a user's touch input that is intended to move the displayed image.

The memory unit 108 includes at least one of Read Only Memory (ROM), Random Access Memory (RAM), flash ROM, and the like. The ROM stores microcodes of programs for processes and controls of the controller 100 and the image rotator 102, and various reference data.

The RAM serves as a working memory of the controller 100 and stores temporary data that is generated and/or used during execution of various programs. In addition, the flash ROM stores various updatable data for storage such as a phonebook, calling messages, and received messages, and stores information regarding a rotation angle that depends on a user's touch input (i.e., movement and direction) according to an exemplary embodiment of the present invention.

The input unit 110 includes a plurality of function keys such as numerical key buttons of 0 to 9, a menu button, a cancel button (i.e., a delete button), an OK button, a TALK button, an END button, an Internet access button, navigation key (or directional key) buttons, letter input keys, and the like. The input unit 110 provides key input data, corresponding to a key pressed by a user, to the controller 100. According to an exemplary embodiment of the present invention, the input unit 110 detects a touch input for rotating an image.

The display unit 112 displays status information generated during an operation of the mobile terminal, letters, moving images and still images, etc. The display unit 112 may be a color Liquid Crystal Display (LCD). The display unit 112 may have a touch input device. When the display unit 112 having the touch input device is applied to a touch input type mobile terminal, the display unit 112 may serve as an input unit.

The communication unit 114 transmits/receives a Radio Frequency (RF) signal of data input/output via an antenna (not illustrated). For example, during transmission, the communication unit 114 channel-codes and spreads data to be transmitted, and then performs an RF process on the signal to transmit the signal. During reception, the communication unit 114 converts a received RF signal into a baseband signal, and despreads and channel-decodes the baseband signal to recover data.

The function of the image rotator 102 may be performed by the controller 100 of the mobile terminal. The separate configuration and illustration of the image rotator 102 are presented herein for convenience in explanation and is not intended to limit the scope of the present invention. It would be obvious to those skilled in the art that various modifications may be made within the scope of the present invention. For example, all of the functions of the image rotator 102 may be processed by the controller 100.

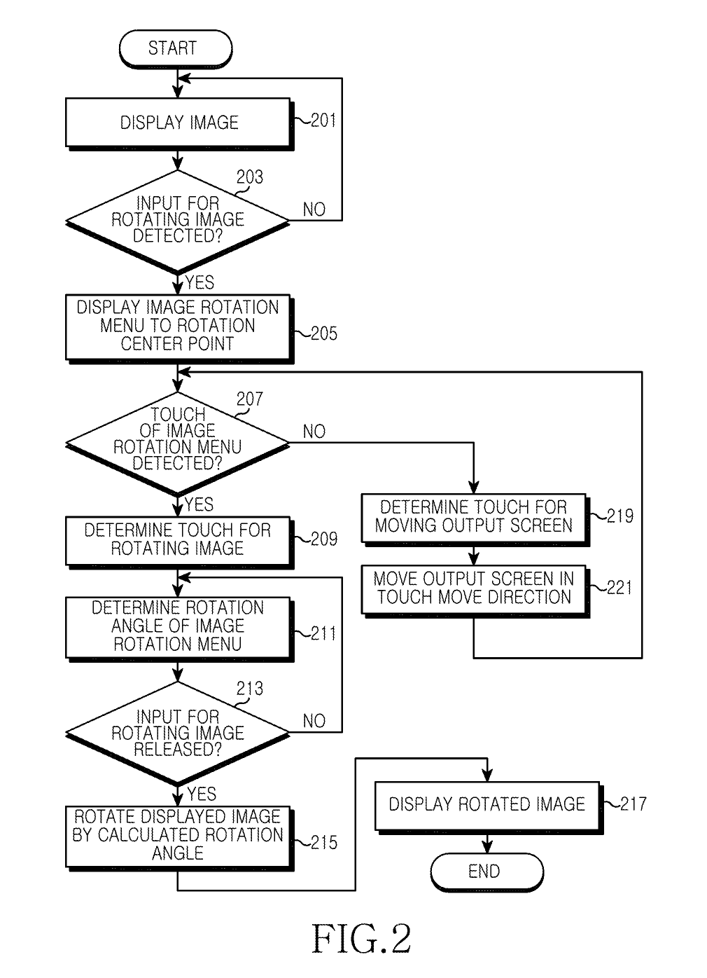

FIG. 2 is a flowchart illustrating a process for rotating a displayed image in a mobile terminal according to an exemplary embodiment of the present invention.

Referring to FIG. 2, the mobile terminal displays an image in step 201, and determines whether a user's touch input for rotating the image that is being displayed is detected in step 203.

When detecting a touch input for rotating an image in step 203, the mobile terminal sets a position where the touch input occurs as a rotation center point and displays an image rotation menu at the set center point in step 205.

Here, the rotation center point denotes a reference point from which a rotation angle of an image that is being displayed is measured.

The mobile terminal determines whether a touch of the image rotation menu by a user is detected in step 207.

Here, the user of the mobile terminal may freely rotate a displayed image in a desired direction and by a desired angle through a touch of the image rotation menu that is being displayed. The image rotation menu may be expressed using a circular diagram including a plurality of blocks. An angle by which an image is to be rotated may be marked at the center of the circular diagram.

For example, in the case where a user of the mobile terminal intends to rotate an image that is being displayed clockwise by 90°, the user performs a clockwise touch movement to a position corresponding to 90° along a block of the image rotation menu.

The block of the image rotation menu denotes an angle to which the displayed image is to be rotated. The mobile terminal may determine an image rotation angle of the mobile terminal using a distance between a block where a touch input initially occurs and a block where the touch input is released.

When not detecting a touch of the image rotation menu by a user in step 207, the mobile terminal determines a touch for moving a displayed screen in step 219, and moves the displayed screen in the touch movement direction in step 221.

The case of not detecting a touch of the image rotation menu by a user in step 207 may be a case of detecting a touch outside the image rotation menu region.

In contrast, when detecting a touch of the image rotation menu by a user in step 207, the mobile terminal determines the user's touch for rotating an image in step 209, and determines a rotation angle of the image rotation menu in step 211.

Here, the rotation angle of the image rotation menu denotes an angle by which a displayed image is to be rotated. The mobile terminal may determine an image rotation angle of the mobile terminal using a distance between a block of the image rotation menu where the touch input initially occurs and a block where the touch input is released. Alternatively, the mobile terminal may determine a rotation angle of an image by defining a rotation angle in advance for every block of the image rotation menu, and then determining the number of blocks over which the user's touch moves. The mobile terminal displays the determined rotation angle of the image rotation menu to the image rotation menu to allow a user to recognize a currently determined rotation angle.

The mobile terminal determines whether a user's input for rotating an image is released in step 213.

When determining that the user's input for rotating an image is not released in step 213, that is, when the user does not determine a rotation angle of the image that is being displayed and performs a touch movement of the image rotation menu, the mobile terminal determines an image rotation angle corresponding to the user's touch movement in step 211.

In contrast, when determining that the user's input for rotating an image is released in step 213, that is, when the user determines a rotation angle of the image that is being displayed and releases the touch input, the mobile terminal rotates the image that is being displayed by a rotation angle set by the user in step 215.

The mobile terminal displays an image rotated by the rotation angle set by the user on the display unit in step 217, and ends the present algorithm.

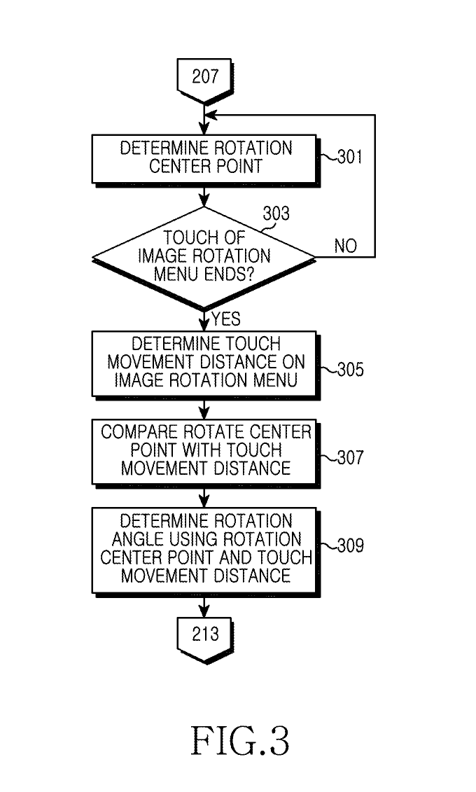

FIG. 3 is a flowchart illustrating a process for determining an image rotation angle in a mobile terminal according to an exemplary embodiment of the present invention.

Referring to FIG. 3, the mobile terminal performs an operation of determining the image rotation angle when detecting a touch of the image rotation menu as in step 207 of FIG. 2.

To determine the image rotation angle, the mobile terminal determines a rotation center point in step 301. Here, the rotation center point denotes a reference point from which a rotation angle of an image that is being displayed is measured. The mobile terminal may set a position where the user's touch input initially occurs as the rotation center point about which the image is rotated.

The mobile terminal determines whether the user's touch input for the image rotation menu ends in step 303. Step 303 serves as an operation for determining whether a touch input for setting the image rotation angle is released.

When not determining the end of the touch of the image rotation menu in step 303, the mobile terminal re-performs an operation of step 301.

In contrast, when determining the end of the touch of the image rotation menu in step 303, the mobile terminal determines the user's touch movement distance that moves on the image rotation menu that is being displayed in step 305.

The mobile terminal compares the rotation center point determined in step 301 with the touch movement distance in step 307, and determines a rotation angle for rotating an image using the rotation center point and the touch movement distance in step 309.

The mobile terminal proceeds to step 213 of FIG. 2 to perform an operation for determining whether the user's touch input for rotating the image is released.

In FIG. 3, as an exemplary embodiment of the present invention, a method for determining an image rotation angle of the mobile terminal using a distance between a block of the image rotation menu where a touch input initially occurs and a block where the touch input is released has been described. Alternatively, the mobile terminal according to an exemplary embodiment of the present invention may define a rotation angle in advance for every block of the image rotation menu, and determine the number of blocks over which the user's touch moves.

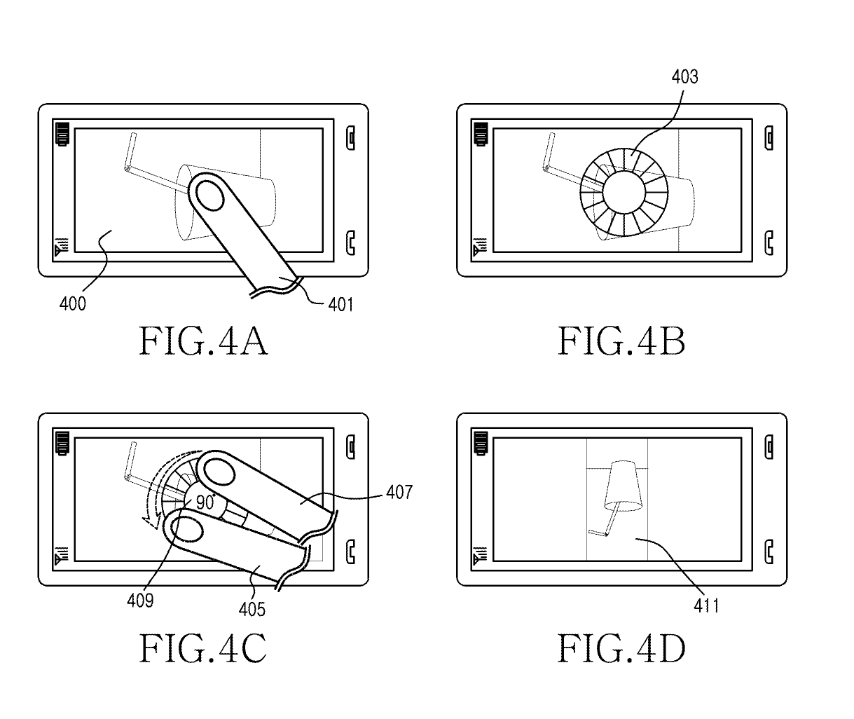

FIGS. 4A-4D are views illustrating a process for rotating an image in a mobile terminal according to an exemplary embodiment of the present invention.

FIG. 4A is a view illustrating a process for executing a function for vertically rotating an image that is being horizontally displayed in a mobile terminal according to an exemplary embodiment of the present invention.

Referring to FIG. 4A, as illustrated, the mobile terminal does not take a posture of a vertical position but takes a horizontal posture in which it is rotated counterclockwise by 90° from the vertical position, and displays an image 400 of a cup. It is assumed that the image 400 of the cup that is being displayed is an image for display in a vertical position and the mobile terminal has been rotated away from a state where the image was being displayed in the vertical position.

In a case of rotating the displayed image, there is an inconvenience of having to enter a menu for managing an image to rotate a relevant image.

However, an exemplary embodiment of the present invention enables rotation of an image that is being displayed using a simple touch input 401.

FIG. 4B is a view illustrating a screen that displays an image rotation menu in a mobile terminal according to an exemplary embodiment of the present invention.

Referring to FIG. 4B, when detecting a user's touch input while an image is being displayed, the mobile terminal sets a position where the touch input occurs as a rotation center point, and displays an image rotation menu 403 using the set rotation center point as a reference.

Here, the rotation center point denotes a reference point from which a rotation angle of an image that is being displayed is measured. In addition, the image rotation menu may be expressed using a circular diagram including a plurality of blocks. An angle by which an image is to be rotated may be marked at the center of the circular diagram.

In the case where a user of the mobile terminal intends to rotate an image, which is being displayed, clockwise by 90°, the user may rotate the image that is being displayed in a direction and by an angle desired by the user by performing a touch movement in a clockwise direction to a position corresponding to 90° along a block of the image rotation menu.

FIG. 4C is a view illustrating a process for setting a rotation angle for rotating an image in a mobile terminal according to an exemplary embodiment of the present invention.

Referring to FIG. 4C, as illustrated, it is assumed that the mobile terminal displays a cup image and the user intends to rotate the image that is being output counterclockwise.

The user will initiate the image rotation menu through a touch input in order to rotate an image. At this point, the image rotation menu is displayed at a position where the user's touch input occurs.

Accordingly, the user of the mobile terminal may rotate the image that is being displayed by moving the touch input from position 407 to position 405 along the blocks of the image rotation menu. In addition, the user may change a rotation angle depending on a movement distance of the touch input. Therefore, the user may freely rotate an image compared to the case of rotating an image through a fixed rotation angle in a conventional mobile terminal. In other words, moving a touch input along the blocks of the image rotation menu denotes a touch input for rotating a displayed image. Moving a touch input at a position outside the block of the image rotation menu denotes an input for moving a displayed image to the touch input movement direction.

In addition, the mobile terminal allows the user to recognize a rotation angle corresponding to a touch movement by determining an image rotation angle and displaying the determined image rotation angle 409 in the image rotation menu.

FIG. 4D is a view illustrating a screen in which an image has been rotated in a mobile terminal according to an exemplary embodiment of the present invention.

Referring to FIG. 4D, when determining that the user intends to rotate an image counterclockwise by 90° through a touch input, the mobile terminal rotates the image that is being displayed counterclockwise by 90° and then displays the image 411.

As described above, exemplary embodiments of the present invention provide an apparatus and a method for rotating a displayed image in a direction and by an angle desired by a user through a simple touch input in a mobile terminal. Exemplary embodiments of the present invention may address the inconvenience of having to enter a separate image management menu when a user intends to rotate an image in the conventional mobile terminal by setting a rotation direction and a rotation angle of a displayed image through a simple touch input.

Although the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for rotating a displayed image in a mobile terminal, the apparatus comprising:
an image rotator for detecting a user's touch input while an image is displayed to determine a rotation direction and a rotation angle for the image, and rotating the displayed image in the determined rotation direction by the determined rotation angle.

2. The apparatus of claim 1, wherein a position where the user's touch input initially occurs is a rotation center point about which the image is rotated.

3. The apparatus of claim 1, wherein when detecting the user's touch input while the image is displayed, the image rotator displays an image rotation menu, determines the rotation angle using a touch movement distance inside the image rotation menu, and determines the rotation direction using a touch movement direction inside the image rotation menu.

4. The apparatus of claim 3, wherein when detecting a touch input outside the image rotation menu, the image rotator moves a screen of the image that is being displayed.

5. The apparatus of claim 4, wherein the image rotation menu is expressible using a circular diagram comprising a plurality of blocks, and the rotation angle is marked at a center of the circular diagram.

6. The apparatus of claim 5, wherein the plurality of blocks serve as blocks for determining the rotation angle, and change the rotation angle depending on a distance of a touch input that moves along the blocks.

7. A method for rotating a displayed image in a mobile terminal, the method comprising:
detecting a user's touch input while an image is displayed to determine a rotation direction and a rotation angle for the image; and
rotating the displayed image in the determined rotation direction by the determined rotation angle.

8. The method of claim 7, wherein a position where the user's touch input initially occurs is a rotation center point about which the image is rotated.

9. The method of claim 7, wherein the detecting of the user's touch input while the image is displayed comprises:
when detecting the user's touch input while the image is displayed, displaying an image rotation menu;
determining the rotation angle using a touch movement distance inside the image rotation menu; and
determining the rotation direction using a touch movement direction inside the image rotation menu.

10. The method of claim 9, wherein the detecting of the user's touch input while the image is displayed further comprises, when detecting a touch input outside the image rotation menu, moving a screen of the image that is being displayed.

11. The method of claim 10, wherein the image rotation menu is expressible using a circular diagram comprising a plurality of blocks, and the rotation angle is marked at a center of the circular diagram.

12. The method of claim 11, wherein the plurality of blocks serve as blocks for determining the rotation angle, and change the rotation angle depending on a distance of a touch input that moves along the blocks.

13. An apparatus for rotating a displayed image in a mobile terminal, the apparatus comprising:
a memory unit for storing information regarding a rotation direction and a rotation angle that depends on at last one of a movement and direction of a user's touch input;
a display unit for displaying a rotated image according to the user's touch input;
an input unit for detecting the user's touch input for rotating an image;
an image rotator for determining a rotation direction and a rotation angle that depends on the user's touch input; and
a controller for controlling to rotate the image displayed on the display unit in the rotation direction by the rotation angle determined by the image rotator.

14. The apparatus of claim 13, wherein a position where the user's touch input initially occurs is a rotation center point about which the image is rotated.

15. The apparatus of claim 13, wherein when detecting the user's touch input for rotating an image, the controller controls to display an image rotation menu.

16. The apparatus of claim 15, wherein the image rotator determines a touch input inside the image rotation menu to determine the rotation angle and the rotation direction.

17. The apparatus of claim 15, wherein the image rotation menu is expressible using a circular diagram comprising a plurality of blocks, and the rotation angle is marked at a center of the circular diagram.

18. The apparatus of claim 17, wherein the plurality of blocks serve as blocks for determining the rotation angle, and change the rotation angle depending on a distance of a touch input that moves along the blocks.
